(19) United States
(12) Patent Application Publication
(10) Pub. No.: US 2007/0130094 A1
(43) Pub. Date: Jun. 7, 2007

(54) Apparatus for rapid model calculation for pattern-dependent variations in a routing system

(75) Inventors: Jung-Cheun Lien, San Jose, CA (US); Minchen Zhao, Palo Alto, CA (US)

Correspondence Address: BIRCH STEWART KOLASCH & BIRCH, PO BOX 747, FALLS CHURCH, VA, 22040-0747, US

(73) Assignee: LIZOTECH, INC.

(21) Appl. No.: 11/633,555

(22) Filed: Dec. 5, 2006

Related U.S. Application Data
(60) Provisional application No. 60/748,447, filed on Dec. 7, 2005.

(51) Int. Cl. G06N 3/02

(52) U.S. Cl. 706/15

(57) ABSTRACT

The invention details apparatus for rapid calculation of models for routing patterns. The calculation comprises learning or self-adapting mechanisms to gradually improve its accuracy. The outputs from such calculation can be used by a routing system to select routing patterns to control variations from manufacturing process. Depending on the model selection, the application areas include but not limited to yield, process window, and timing variations.

### CLAIM OF BENEFIT TO PROVISIONAL APPLICATION

This patent application claims the benefit of the earlier-filed U.S. Provisional Patent Application entitled “Methods and Apparatus for Rapid Model Calculation for Pattern-Dependent Variations in a Routing System”, having Ser. No. 60/748,447, and filed Dec. 7, 2005.

### BACKGROUND OF THE INVENTION

1. Field of the Invention

The present invention relates to an apparatus for rapid model calculation for pattern-dependent variations in a routing system. In particular, this invention relates to an apparatus for rapid model calculation having learning or self-adapting mechanisms.

2. Description of the Related Art

Routing pattern can greatly impact an integrated circuit IC in many ways. The major impact is “variations” that can degrade both yield and timing of a design. Such variations can be systematic or random. Some use variation to refer to system behavior and variability to refer to random behavior. In this invention, we do not differentiate them. We use the terms interchangeably herein. When calculating for selected model, which describe an important aspect of IC design, such as yield or timing, different routing patterns often results in different outputs. Such difference is referred to as variation hereafter.

FIG. 1 depicts the concept of variation caused by different routing patterns. A routing pattern 110 is an input to a calculator 120 which consists of a model calculator and a technology. The calculator produces Output 1. Another routing pattern 112 is an input to an identical calculator 122 that produces Output 2. The difference between Output 1 and 2 is called pattern-dependent variations.

The process window of a given routing can be affected by its neighbors. Defined by a Bossung Plot with attributes such as critical dimension (CD), depth of focus (DOF), exposure latitude (EL), the process window of a routing pattern represents how “easy” a given routing can be manufactured properly.

FIG. 2 depicts an example of obtaining process window from a process simulator. Given a layout pattern 210 as input to a process simulator 220 which has a defined process technology, the output is a process window 1 defined by CD1, DOF1, and EL1. Similarly, 212 is a different routing pattern. A process simulator 222 is the same process simulator as in 220. The output is a different process window 2 defined by CD2, DOF2, EL2. The difference between process window 1 and 2 are called pattern-dependent process window variations.

The timing values of a wire can be affected by its neighbors due mainly to process variations, RET steps and cross coupling.

FIG. 3 depicts an example where the important timing variables resistance R, inductance L, and capacitance C or RLC of a wire W1 vary according to the pattern of its neighboring wires. The layout pattern 310 contains just a wire W1. The extractor 320 uses a 3-D solver to calculate RLC of wire W1. The calculated values are R1, L1 and C1 respectively. Similarly, the layout pattern 320 contains a wire W1, which is identical to that of 310, and its neighbors W2, W3. The extractor 322 is actually identical to 320. The calculated RLC values for wire W1 are R2, L2, and C2. The RLC differences among R1, R2, L1, L2, and C1, C2 are called pattern-dependent timing variations.

A common way for model calculation is by a so called table look-up technique, where a large set of pre-computed input and output are stored. The calculation of the table data can be done separately, and often done offline. The real-time model calculation thus becomes simple table look-up. No learning or adapting mechanism is involved in the calculation. There is no a good outputs from the existed model to control variations from manufacturing process.

### SUMMARY OF THE INVENTION

One particular aspect of the present invention is to provide an apparatus for rapid model calculation for pattern-dependent variations in a routing system. The invention details apparatus for rapid calculation of models for routing patterns. The calculation comprises learning or self-adapting mechanisms to gradually improve its accuracy. The outputs from such calculation can be used by a routing system to select routing patterns to control variations from manufacturing process. Depending on the model selection, the application areas include but not limited to yield, process window, and timing variations.

A further particular aspect of the present invention is to depict an apparatus to perform rapid model calculation that can be used in a router system. The calculator includes a learning or adapting mechanism to improve its accuracy as it continuously evolves. A knowledge base is often used to keep track of the knowledge learned.

In a preferred embodiment, the apparatus including a model calculation system comprises at least one input including a routing pattern of an integrated circuit layout, at least one output, and a calculator having a learning mechanism for continuously improving accuracy. The calculator receives the input and process the input by using the leaning mechanism to generate the out.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of variations in model caused by routing patterns;

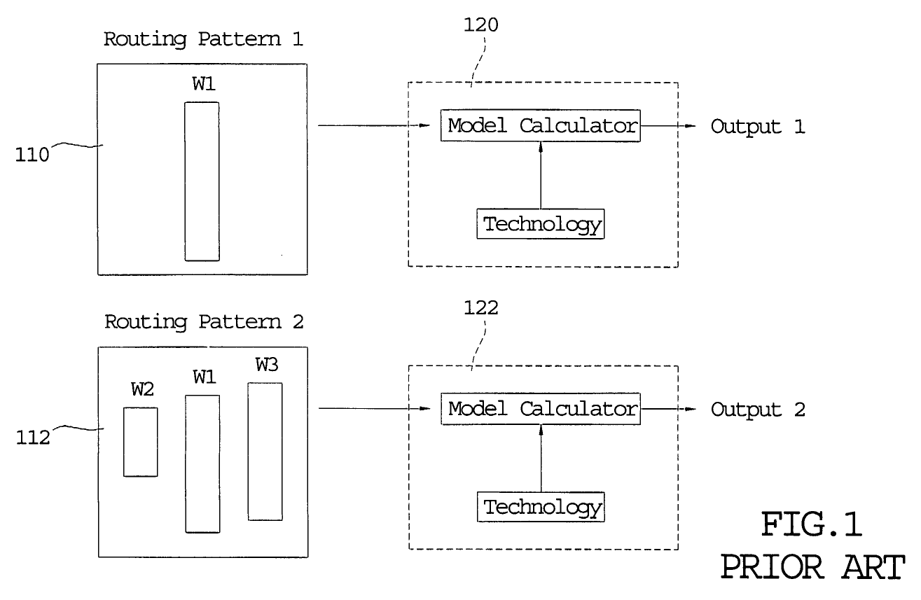

FIG. 2 is a schematic diagram of variations in process window sizes of two routing patterns;

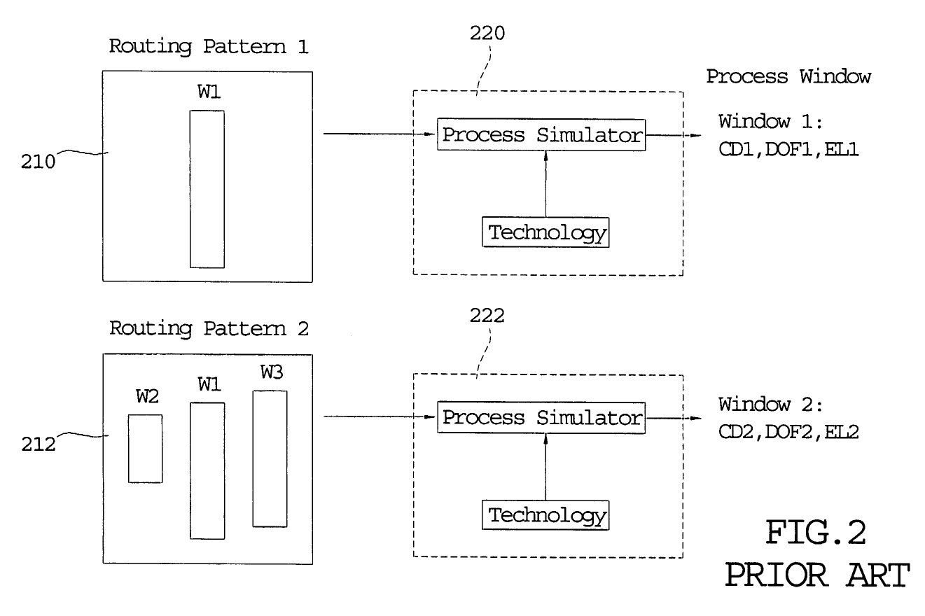

FIG. 3 is a schematic diagram of variations in timing value of two routing patterns;

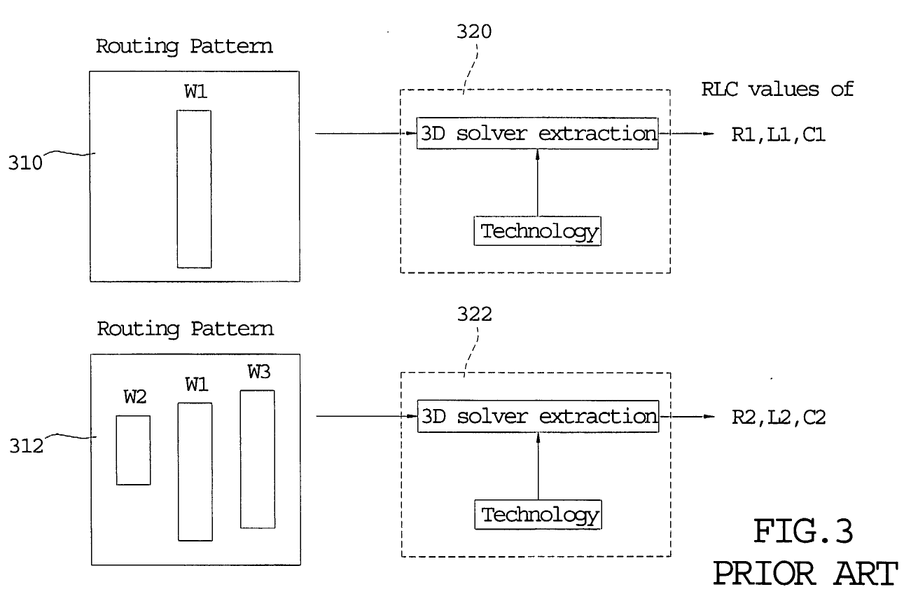

FIG. 4 is a schematic diagram of a model calculation system in learning mode of the present invention;

FIG. 5 is a schematic diagram of a model calculation system in application mode of the present invention;

FIG. 6 is a schematic diagram of merging/combining knowledge bases into a complete knowledge base of the present invention;

FIG. 7 is a schematic diagram of a neural network using in the present invention;

FIG. 8 is a schematic diagram of a processing unit in the neural network of the present invention; and

FIG. 9 is a schematic diagram of incorporating model into a routing system of the present invention.

### DETAILED DESCRIPTION OF THE PREFERRED EMBODIMENTS

The invention depicts an apparatus to perform rapid model calculation that can be used in a router system. The calculator includes a learning or adapting mechanism to improve its accuracy as it continuously evolves. A knowledge base is often used to keep track of the knowledge learned.

Two types of calculators are used in the model calculation system, namely accurate calculator and rapid calculator. The former can be slow while the latter can be less accurate. The system consists of two operation modes: a learning mode and an application mode. In the learning mode, the accurate calculator produces outputs served as a reference that are fed into the rapid calculator along with its output. The rapid calculator may produce outputs that are inaccurate initially. A knowledge base is gradually built up after many learning iterations. The accuracy improved as the knowledge grows. When the rapid calculator can consistently produce fairly accurate output, it then enters the application mode. In the application mode, while the learning process can still continue with self feedback, the accurate calculator is no longer needed. The rapid calculator can produce fairly accurate output rapidly based on its continuously evolving knowledge base.

The knowledge base is both technology and model dependent. A knowledge base must be built for each process technology and for each model selected, and is obtained offline in advance. To do calculation for a new technology or a new model, one just needs to replace the underlying knowledge base.

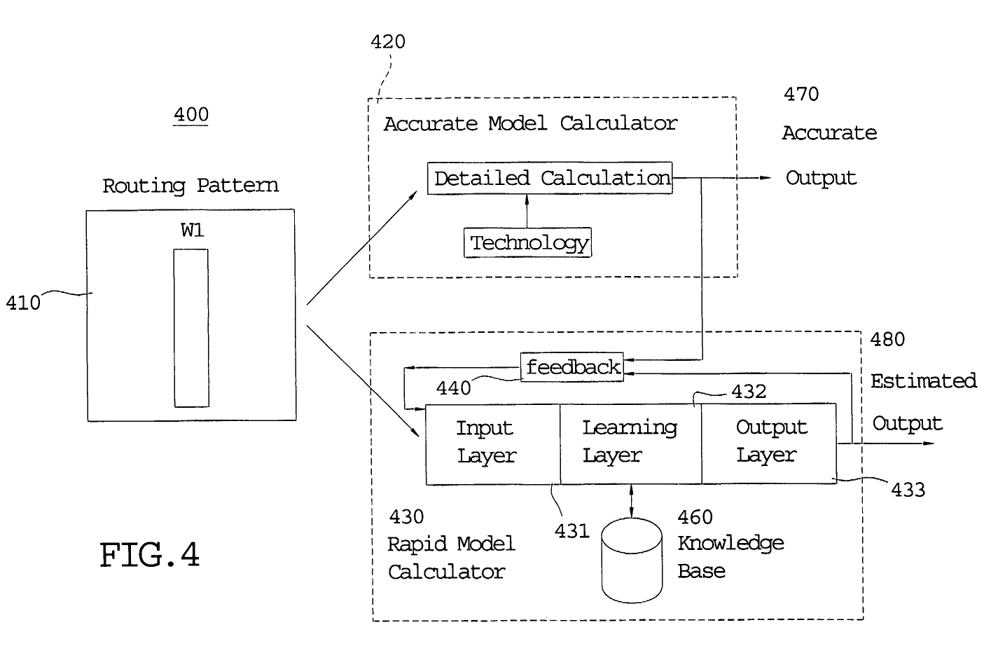

FIG. 4 depicts a model calculator 400 in learning mode. The input is a routing pattern 410 of an integrated circuit layout. An accurate model calculator 420 accepts the routing input and produce accurate output 470. Based on the selected process technology, a detailed calculation is performed. This calculation usually is time consuming and thus cannot be deployed directly in a routing system, which may require millions of such operations to be performed. The process technology is described in details. All factors/variables that can impact the model calculation are required.

The rapid model calculator 430 consists of three layers. The input layer 431 has two types of inputs, namely, the routing pattern 410 and the output of a feedback function 440. One example of the feedback function 440 is simply the difference between the two inputs namely, accurate output 470 and output 480. The hidden or learning layer 432 can learn from past calculations and store the knowledge in its knowledge base 460. The knowledge base 460 is technology dependent. For each process technology and each model, a knowledge base is required. The output layer 433 can produce output rapidly.

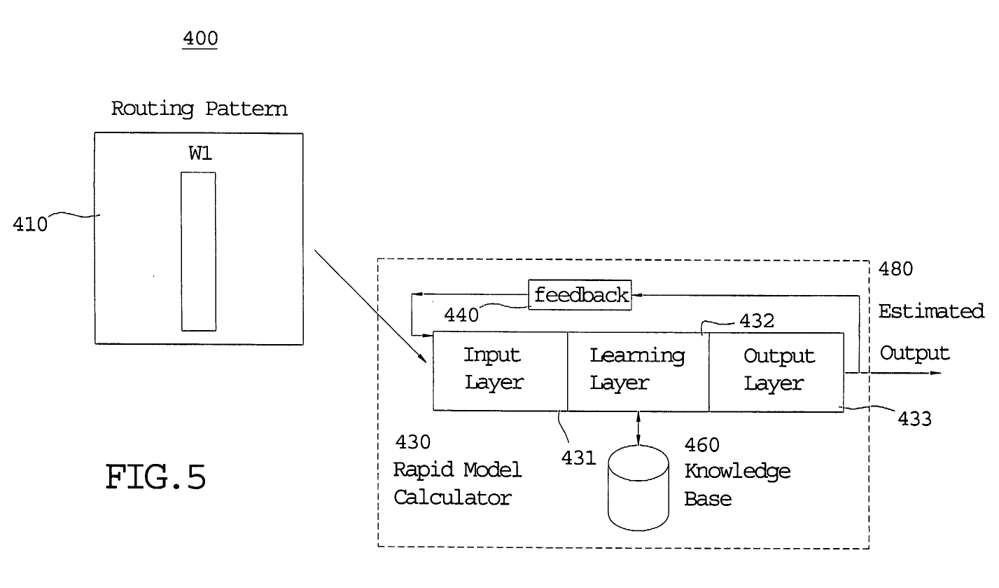

FIG. 5 depicts the rapid model calculator in application mode. Utilizing the knowledge base 460 built from the learning mode, the calculator can produce a fairly accurate output 480 rapidly given any input pattern 410. The feedback function 440 is still included in this mode, making the learning process continuously while in the application mode. Note that when switching to a new process technology, the appropriate knowledge base obtained from that technology must be used.

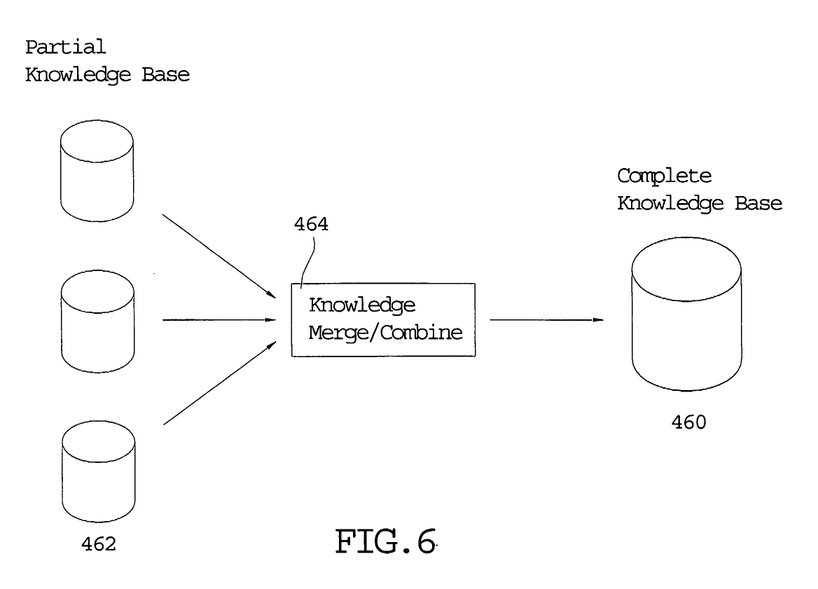

One way to speed up the learning process is to use parallel processing concept. To speed up the learning process, it is possible to divide the set of inputs into smaller subsets. Each subset of inputs can execute in parallel using the method described in FIG. 4. A partial knowledge base 462 is built up for each subset. After the learning is done for all inputs, another step is executed to merge or combine all the partial knowledge bases 462 into a complete knowledge base 460. FIG. 6 depicts such a merging procedure. Multiple partial knowledge bases 462 are merged through knowledge merging processing module 464, producing a final complete knowledge base 460. This knowledge base 460 is then used in application mode as shown in FIG. 5.

Furthermore, the model calculator also uses a curve-fitting algorithm and/or interpolation technique to speed up the learning process.

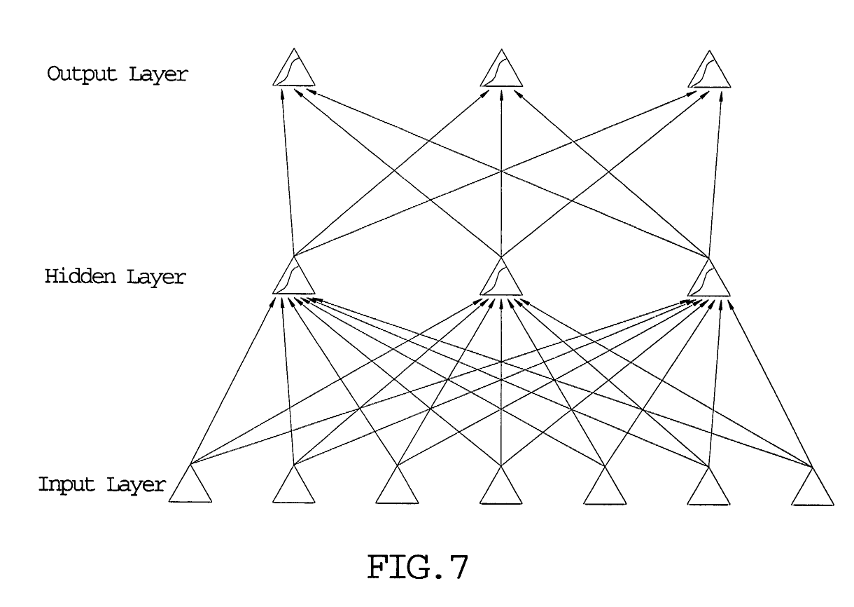

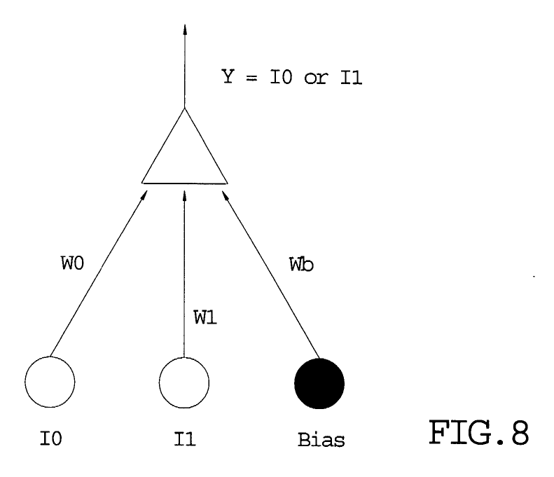

The model calculator described in this invention can be implemented in different ways. We use a Neural Network shown in FIG. 7 as an example. A typical Neural Network comprises three layers, namely an input layer, a hidden or learning layer along with a knowledge base, and an output layer. FIG. 8 shows a typical implementation of a processing unit. The network has 2 inputs, and one output. The output is:
1 if W0*10+W1*11+Wb>0
0 if W0*10+W1*11+Wb<=0

In learning mode, the Network learns according to current input and the difference between output and reference output. In the application mode, the Network can produce fairly accurate output rapidly.

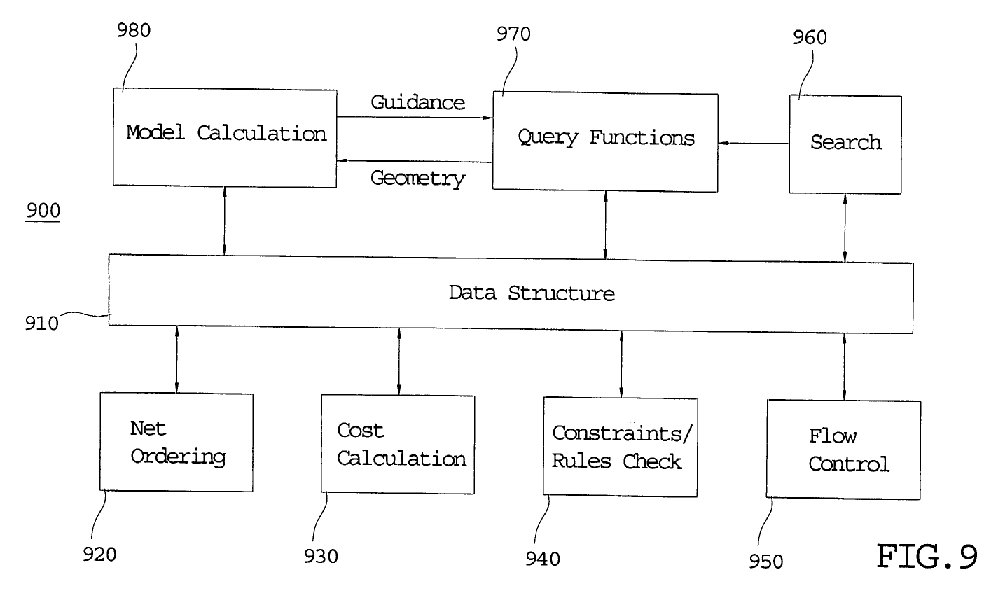

FIG. 9 elaborates how models are used in a detail router 900. At the core of the detail router 900 is data structure 910 that allows all processing steps of the detail router 900 to share information. Module 920 orders nets to be processed by the router 900 in an optimal way. Module 930 calculates costs for routing current net. Module 940 performs check on rules and constraints for the routing. Box Module is a flow control that put the entire router 900 together. Module 960 is the main search engine for the detail router 900. The search engine needs to do frequent queries. Module 970 represents various query functions that support the search. Some query function get guidance from the model calculator 980 by providing specific geometry information. The routing system adopts the present model calculation system to calculate variations caused by routing patterns with regard to selected models, and the routing system chooses the routing patterns that produce minimal variation for the model. For combining effects of variations produced by multiple models, the routing system uses one of the operations, including superposition operations, set intersection operations, algebraic operations, geometric algebra operations, linear algebra operations, correlation operation, and convolution operations.

Therefore, the apparatus for rapid model calculation for pattern-dependent variations in a routing system uses a learning or self-adapting mechanisms to gradually improve its accuracy. The outputs from such calculation can be used by a routing system to select routing patterns to control variations from manufacturing process.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An apparatus including a model calculation system, comprising:
at least one input including a routing pattern of an integrated circuit layout;
at least one output; and
a calculator having a learning mechanism for continuously improving accuracy; wherein the calculator receives the input and process the input by using the leaning mechanism to generate the output.

2. The apparatus including a model calculation system as claimed in claim 1, wherein the apparatus is used in an integrated circuit routing system.

3. The apparatus including a model calculation system as claimed in claim 1, wherein the calculator is a Neural Network.

4. The apparatus including a model calculation system as claimed in claim 1, wherein the calculator uses a curve-fitting algorithm and/or interpolation technique.

5. An apparatus including a model calculation system, comprising:
at least one input including a routing pattern of an integrated circuit layout;
at least one knowledge base;
at least one output; and
a calculator having a learning mechanism for continuously improving accuracy; wherein the calculator receives the input and process the input by using the leaning mechanism and to generate the knowledge base and the out.

6. The apparatus including a model calculation system as claimed in claim 5, wherein the knowledge base is process technology and model dependent.

7. The apparatus including a model calculation system as claimed in claim 5, wherein the apparatus is used in an integrated circuit routing system.

8. The apparatus including a model calculation system as claimed in claim 5, wherein the calculator is a Neural Network.

9. The apparatus including a model calculation system as claimed in claim 5, wherein the calculator uses a curve-fitting algorithm and/or interpolation technique.

10. The apparatus including a model calculation system as claimed in claim 5, wherein the knowledge base is obtained offline in advance.

11. The apparatus including a model calculation system as claimed in claim 5, wherein the knowledge base continuously improves during application.

12. An apparatus including a model calculation system, comprising:
at least one input including a routing pattern of an integrated circuit layout;
an accurate calculator to produce reference output;
a rapid calculator to produce estimate output, wherein the rapid calculator has a learning mode and an application mode, at the learning mode, both the reference and estimated outputs are used by the rapid calculator, the rapid calculator builds up a knowledge base using a learning mechanism, and at the application mode, the estimated output produced by the rapid calculator is the system output, and learning or self-adapting process continues in this mode;
at least one output coming from the estimated output of the rapid calculator.

13. The apparatus including a model calculation system as claimed in claim 12, wherein the knowledge base is process technology and model dependent.

14. The apparatus including a model calculation system as claimed in claim 12, wherein the apparatus is used in an integrated circuit routing system.

15. The apparatus including a model calculation system as claimed in claim 12, wherein the calculator is a Neural Network with at least one hidden layer.

16. The apparatus including a model calculation system as claimed in claim 12, wherein the calculator uses a curve-fitting algorithm and/or interpolation technique.

17. The apparatus including a model calculation system as claimed in claim 12, wherein the knowledge base is obtained offline in advance.

18. The apparatus including a model calculation system as claimed in claim 12, wherein the knowledge base continuously improves during the application mode.

19. The apparatus including a model calculation system as claimed in claim 12, wherein the rapid calculator further comprises:
an input layer accepting the routing pattern and output of a feedback function;
an learning layer including a knowledge base that learns from past calculations and stores the knowledge in the knowledge base; and
an output layer producing the output.

20. The apparatus including a model calculation system as claimed in claim 12, further comprising:
means for dividing the input into multiple subsets;
a plurality of partial knowledge bases built for each input subsets by using the rapid calculator; and
a merging operation module for combining the partial knowledge bases into a single knowledge base.

21. The apparatus including a model calculation system as claimed in claim 20, wherein merging operation of the merging operation module is identical to the knowledge building mechanism at the learning mode.

22. A routing system, comprising:
at least one model calculation system, wherein the model calculation system is used to calculate variations caused by routing patterns with regard to selected models, and the routing system chooses the routing patterns that produces minimal variation for the model.

23. The routing system as claimed in claim 22, wherein the routing system uses one of the following operations to combine effects of variations produced by multiple models:
superposition operations;
set intersection operations;
algebraic operations;
geometric algebra operations;
linear algebra operations;
correlation operations; and
convolution operations.
